(19) United States
(12) Patent Application Publication
(10) Pub. No.: US 2025/0039773 A1
(43) Pub. Date: Jan. 30, 2025

(54) COMMUNICATION SYSTEMS USING UNSOURCED RANDOM ACCESS WITH FEEDBACK SIGNALING AND METHODS AND NON-TRANSITORY COMPUTER-READABLE STORAGE MEDIA THEREFOR

(71) Applicants: Huawei Technologies Canada Co., Ltd., Kanata (CA); Dalhousie University, Hailifax (CA)

(72) Inventors: Murwan Bashir, Kanata (CA); Dmitry Trukhachev, Kanata (CA); Monirosharieh Vameghestahbanati, Kanata (CA); Alireza Bayesteh, Kanata (CA); Yan Chen, Kanata (CA)

(21) Appl. No.: 18/917,089

(22) Filed: Oct. 16, 2024

Related U.S. Application Data
(63) Continuation of application No. PCT/CN2022/088828, filed on Apr. 24, 2022.

(51) Int. Cl. H04W 48/10; H04W 74/0833

(52) U.S. Cl. CPC H04W 48/10; H04W 74/0833

(57) ABSTRACT

A method executed by a receiving device for providing feedback to a plurality of transmitting devices regarding reception of data packets transmitted from the transmitting devices include determining that one or more first packets transmitted from one or more first communication devices of the transmitting devices are received and decoded, adding one or more identifiers of the one or more first communication devices to a feedback section of a message, and broadcasting the message to the transmitting devices. The determination of adding the identifiers of the one or more first communication devices to the message is based on one or more channel thresholds. The transmitting devices, after receiving the message, checks if an amplitude of the channel is smaller than a first threshold, checking if retransmission of the data packet is required based on the message, and retransmitting the data packet if the retransmission of the data packet is required.

### CROSS-REFERENCE TO RELATED APPLICATIONS

This application is a continuation of Patent Cooperation Treaty Application Serial No. PCT/CN2022/088828, filed Apr. 24, 2022, the content of which is incorporated herein by reference in its entirety.

### TECHNICAL FIELD

The present disclosure relates generally to communication systems and methods, and in particular to communication systems using unsourced random access with feedback signaling and methods and non-transitory computer-readable storage media therefor.

### BACKGROUND

For ease of reading, subsection C of the Detailed Description lists the acronyms used in this disclosure. Subsection D of the Detailed Description lists the acronyms used in this disclosure, the content of each of which is incorporated herein by reference in its entirety.

Unsourced random access (URA) (see References [R1] to [R7], [R14] and [R16]) is a type of grant-free random access with a large number of active and inactive user equipments (UEs; also denoted “users”) in communication with a receiver such as a transmit/receive point (TRP). In URA, each user employs the same codebook and the task of the receiver is to decode the list of transmitted messages irrespective of the identity of the users. The number of inactive users in URA may be arbitrarily large and the performance of the system depends only on the number of active users. Furthermore, a transmission protocol without the need for a subscriber identity is well suited for mass production. These features make U-RA particularly interesting for the aforementioned IoT applications. The transmission links from the UEs to the TRP are denoted feed-forward (FF) links.

The UEs transmit data signals or packets via the FF links to the TRP in a grant-free manner, without pre-allocation of time or bandwidth resources. Moreover, The UEs usually have limited power/computational resources and transmit small data packets in sporadic manner.

Compared to the typical random or massive multiple access, URA has a few distinctive features. For example, while the number of UEs may be very large, at every given time, only a subset of UEs are active. The UEs usually have no pre-assigned unique user-identifiers. Moreover, the successful delivery of the data to the TRP is more important than the TRP knowing the origin of the data (that is, knowing the identity of the UE from which a data pack is received from). Thus, the UEs may retransmit (and sometimes frequently retransmit) their data signals to the TRP to ensure successful data delivery. The per-user probability of error is often used as a performance indicator while error-free reception of all messages is not required.

### SUMMARY

Embodiments disclosed herein relate to wireless communication systems having a transmit/receive point (TRP) and one or more user equipments (UEs). The one or more UEs are configured for transmitting data signals via feed-forward (FF) links to the TRP using unsourced random access (URA).

According to one aspect of this disclosure, the wireless communication system uses a feedback (FB) method to allow a transmit/receive point (TRP) to send acknowledgments or feedbacks to one or more user equipments (UEs) about the reception status of their data signals on the FF links. By using the feedbacks, UEs may conserve UE power squandered by frequent re-transmissions. With simple and efficient feedback signaling, the feedback method may also improve the per-user error probability (PUPE).

According to one aspect of this disclosure, there is provided a method comprising: broadcasting a message to a plurality of communication devices; the message comprises one or more first identifiers representing one or more first communication devices of the plurality of communication devices; and one or more first packets transmitted from the one or more first communication devices via one or more first channels have been successfully received and decoded, and amplitudes of the one or more first channels are smaller than a first threshold.

In some embodiments, the one or more first identifiers comprise one or more first preambles of the one or more first communication devices.

In some embodiments, the one or more first identifiers are associated with a first feedback type.

In some embodiments, the message further comprises one or more second identifiers representing one or more second communication devices of the plurality of communication devices; and one or more second packets transmitted from the one or more second communication devices via one or more second channels have been received but failed to decode, and amplitudes of the one or more second channels are greater than the first threshold.

In some embodiments, the one or more second identifiers are associated with a second feedback type.

In some embodiments, the message further comprises one or more second identifiers associated with a second feedback type, the one or more second identifiers representing one or more second communication devices of the plurality of communication devices; and one or more second packets transmitted from the one or more second communication devices via one or more second channels have been received but failed to decode, and amplitudes of the one or more second channels are smaller than the first threshold and greater than a second threshold.

In some embodiments, the one or more second identifiers comprise one or more second preambles of the one or more second communication devices.

In some embodiments, the message further comprises a first pilot signal.

In some embodiments, the message further comprises a second pilot signal, the second pilot signal being the first pilot signal multiplied by the first threshold.

In some embodiments, the message further comprises a third pilot signal, the third pilot signal being the first pilot signal multiplied by the second threshold.

According to one aspect of this disclosure, there is provided an apparatus comprising a processing unit for: broadcasting a message to a plurality of communication devices; the message comprises one or more first identifiers representing one or more first communication devices of the plurality of communication devices; and one or more first packets transmitted from the one or more first communication devices via one or more first channels have been successfully received and decoded, and amplitudes of the one or more first channels are smaller than a first threshold.

According to one aspect of this disclosure, there is provided one or more non-transitory computer-readable storage devices comprising computer-executable instructions, wherein the instructions, when executed, cause a processor to perform actions comprising: broadcasting a message to a plurality of communication devices; the message comprises one or more first identifiers representing one or more first communication devices of the plurality of communication devices; and one or more first packets transmitted from the one or more first communication devices via one or more first channels have been successfully received and decoded, and amplitudes of the one or more first channels are smaller than a first threshold.

According to one aspect of this disclosure, there is provided a method performed by a first communication device having a first identifier, the method comprising: receiving and decoding a message from a second communication device via a channel; checking if retransmission of a data packet is required at least based on a comparison between an amplitude of the channel and a first threshold; and retransmitting the data packet if the retransmission of the data packet is required.

In some embodiments, said checking if the retransmission of the data packet is required comprises: determining that the retransmission of the data packet is required, if the amplitude of the channel is greater than the first threshold and the first identifier is included in the message, or if the amplitude of the channel is greater than the first threshold and the first identifier associated with a negative indicator is included in the message.

In some embodiments, said checking if the retransmission of the data packet is required comprises: determining that the retransmission of the data packet is required if the amplitude of the channel is smaller than the first threshold and the first identifier is not included in the message.

In some embodiments, said checking if the retransmission of the data packet is required comprises: checking if the retransmission of the data packet is required at least based on a comparison of the amplitude of the channel to the first threshold and a second threshold, the first threshold being greater than the second threshold.

In some embodiments, said checking if the retransmission of the data packet is required comprises: determining that the retransmission of the data packet is required if the amplitude of the channel is smaller than the second threshold.

In some embodiments, said checking if the retransmission of the data packet is required comprises: determining that the retransmission of the data packet is required, if the amplitude of the channel is smaller than the first threshold and greater than the second threshold and the first identifier is not included in the message, or if the amplitude of the channel is smaller than the first threshold and greater than the second threshold and the first identifier associated with a negative indicator is included in the message.

In some embodiments, the method further comprises: retrieving the first threshold from the message.

In some embodiments, the method further comprises: retrieving the second threshold from the message.

In some embodiments, the method further comprises: retrieving a first pilot signal from the message; and estimating the amplitude of the channel using the pilot signal.

In some embodiments, said retrieving the first threshold from the message comprises: retrieving a second pilot signal from the message; and determining the first threshold by comparing the first and second pilot signals.

In some embodiments, said retrieving the second threshold from the message comprises: retrieving a third pilot signal from the message; and determining the second threshold by comparing the first and third pilot signals.

According to one aspect of this disclosure, there is provided an apparatus comprising: a processing unit for: receiving and decoding a message from a second communication device via a channel; checking if retransmission of a data packet is required at least based on a comparison between an amplitude of the channel and a first threshold; and retransmitting the data packet if the retransmission of the data packet is required.

According to one aspect of this disclosure, there is provided one or more non-transitory computer-readable storage devices comprising computer-executable instructions, wherein the instructions, when executed, cause a processor to perform actions comprising: receiving and decoding a message from a second communication device via a channel; checking if retransmission of a data packet is required at least based on a comparison between an amplitude of the channel and a first threshold; and retransmitting the data packet if the retransmission of the data packet is required.

According to one aspect of this disclosure, there is provided a method comprising: determining that one or more first packets transmitted from one or more first communication devices of a plurality of communication devices via one or more first channels are received but failed to decode, the one or more first communication devices associated with one or more first identifiers; adding the one or more first identifiers to a message; and broadcasting the message to the plurality of communication devices.

According to one aspect of this disclosure, there is provided a method comprising: determining that one or more first packets transmitted from one or more first communication devices of a plurality of communication devices via one or more first channels are received and decoded, the one or more first communication devices associated with one or more first identifiers; adding the one or more first identifiers to a message; and broadcasting the message to the plurality of communication devices.

By using the methods, apparatuses, and one or more non-transitory computer-readable storage devices described above, a communication system such as an unsourced random access (URA) system having a transmit-receive point (TRP) receiving data packets from a plurality of user equipments (UEs) may provide feedback to the UEs to allow the UEs to effectively and efficiently determine the success or failure of their data-packet transmissions with reduced computational cost and power consumption.

### BRIEF DESCRIPTION OF THE DRAWINGS

FIG. 1 is a simplified schematic diagram showing the structure of a communication system, according to some embodiments of this disclosure, wherein the communication system is an unsourced random access (URA) system;

FIG. 2 is a simplified schematic diagram of a controlling device of a communication network of the communication system shown in FIG. 1;

FIG. 3 is a simplified schematic diagram of a transmit-receive point (TRP) of the communication system shown in FIG. 1;

FIG. 4 is a simplified schematic diagram of a user equipment (UE) of the communication system shown in FIG. 1;

FIG. 5 is a schematic diagram showing a TRP shown in FIG. 3 communicating with UEs shown in FIG. 4 in the URA system shown in FIG. 1 using a feedback signaling method, according to some embodiments of this disclosure;

FIG. 6 is schematic diagram showing a data packet sent from a UE shown in FIG. 4 to the TRP shown in FIG. 3 via a feed-forward (FF) link therebetween, according to some embodiments of this disclosure;

FIG. 7 is a sequence diagram showing a process performed by one or more UEs shown in FIG. 4 and the TRP shown in FIG. 3 for data transmissions from the UEs to the TRP using URA, according to some embodiments of this disclosure;

FIG. 8 is schematic diagram showing a process executed by the TRP shown in FIG. 3 for processing the data packets received from the UEs shown in FIG. 4, according to some embodiments of this disclosure;

FIG. 9 shows an example of UE classification using a single threshold after the TRP shown in FIG. 3 finishes processing of the received packets using the process shown in FIG. 8, according to some embodiments of this disclosure;

FIG. 10 is schematic diagram showing a feedback message broadcast from the TRP shown in FIG. 3 to the UEs shown in FIG. 4, according to some embodiments of this disclosure;

FIG. 11 is schematic diagram showing a feedback message broadcast from the TRP shown in FIG. 3 to the UEs shown in FIG. 4, according to some embodiments of this disclosure, wherein the feedback message comprises a single channel threshold;

FIG. 12 is a flowchart showing a process executed by the TRP shown in FIG. 3 for generating a feedback message having the structure shown in FIG. 11, according to some embodiments of this disclosure;

FIG. 13 is a flowchart showing a feedback-detection process performed by a UE shown in FIG. 4 for processing the feedback message having the structure shown in FIG. 11 and generated by the TRP shown in FIG. 3 using the process shown in FIG. 12, according to some embodiments of this disclosure;

FIG. 14 is a sequence diagram showing more details of the process shown in FIG. 7 with dynamic signaling exchange between the UE shown in FIG. 4 and the TRP shown in FIG. 3, according to some embodiments of this disclosure;

FIG. 15 is a flowchart showing a process executed by the TRP shown in FIG. 3 for generating a feedback message having the structure shown in FIG. 11, according to some other embodiments of this disclosure;

FIG. 16 is a flowchart showing a feedback-detection process performed by a UE shown in FIG. 4 for processing the feedback message having the structure shown in FIG. 11 and generated by the TRP shown in FIG. 3 using the process shown in FIG. 15, according to some embodiments of this disclosure;

FIG. 17 is schematic diagram showing a feedback message broadcast from the TRP shown in FIG. 3 to the UEs shown in FIG. 4, according to some embodiments of this disclosure, wherein the feedback message comprises two channel thresholds;

FIG. 18 shows an example of UE classification using two channel thresholds after the TRP shown in FIG. 3 finishes processing of the received packets using the process shown in FIG. 8, according to some embodiments of this disclosure;

FIG. 19 is a flowchart showing a process executed by the TRP shown in FIG. 3 for generating a feedback message having the structure shown in FIG. 17, according to some embodiments of this disclosure;

FIG. 20 is a flowchart showing a feedback-detection process performed by a UE shown in FIG. 4 for processing the feedback message having the structure shown in FIG. 17 and generated by the TRP shown in FIG. 3 using the process shown in FIG. 19, according to some embodiments of this disclosure;

FIG. 21 is a flowchart showing a process executed by the TRP shown in FIG. 3 for generating a feedback message having the structure shown in FIG. 17, according to some other embodiments of this disclosure; and

FIG. 22 is a flowchart showing a feedback-detection process performed by a UE shown in FIG. 4 for processing the feedback message having the structure shown in FIG. 17 and generated by the TRP shown in FIG. 3 using the process shown in FIG. 21, according to some embodiments of this disclosure.

### DETAILED DESCRIPTION

### A. System Structure

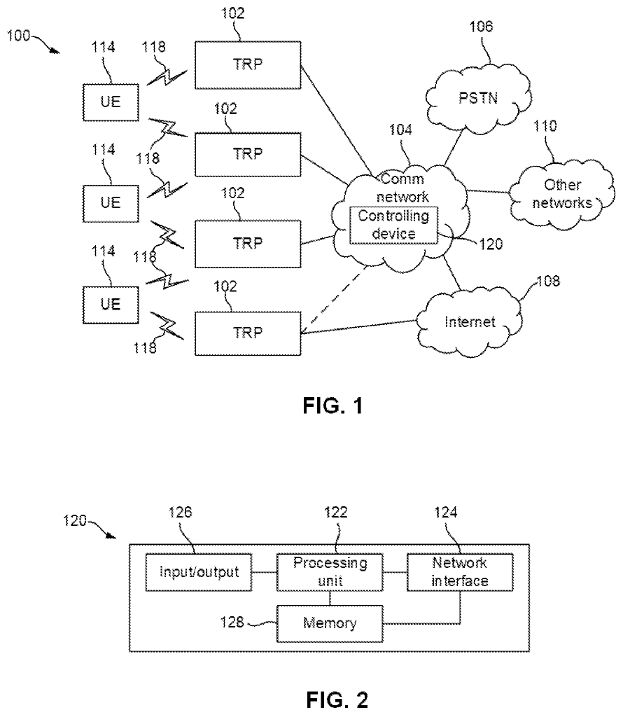

Turning now to FIG. 1, a communication system is shown and is generally identified using reference numeral 100. As shown, the communication system 100 comprises a plurality of transmit-receive points (TRPs) 102 (also denoted “communication nodes” hereinafter) in communication with a communication network 104 and in turn with one or more public switched telephone networks (PSTNs) 106, the Internet 108, and other networks 110 via the communication network 104. Some TRPs 102 may access the communication network 104 via the Internet 108. Some TRPs 102 may also directly communicate with each other.

A plurality of communication devices such as a plurality of user equipments (UEs) 114 are in wireless communication with the TRPs 102 for accessing the communication network 104, the PSTNs 106, the Internet 108, and other networks 110 for sending and/or receiving data (for example, sending/receiving emails, sending/receiving instant messages, and/or the like), accessing contents (such as text content, audio content, and/or video content), making and/or receiving phone calls (to, for example, other UEs 114, landline phones (not shown), and/or the like), and/or the like. Examples of UEs 114 may be smartphones, personal digital assistants (PDAs), laptops, computers, tablets, vehicles, sensors, and/or the like.

As those skilled in the art will appreciate, the communication system 100 may operate by sharing resources such as bandwidth, and allow data transmission (for example, transmission of voice, data, video, text, and/or the like) via broadcast (one device to all devices in the system 100; that is, one-to-all), multicast (one device to a plurality of device; that is, one-to-many), unicast (one device to another device such as one UE to another UE; that is, one-to-one), and/or the like.

The communication system 100 may employ suitable multiple access technologies for communications between the UEs 114 and the TRPs 102 via uplinks from UEs 114 to TRPs 102 and/or via downlinks from TRPs 102 to UEs 114, and/or between UEs 114 via sidelinks therebetween. Examples of multiple access technologies may be time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like. Recently, non-orthogonal multiple access (NoMA) technologies have been used for efficiently sharing the physical resource for wireless communication wherein a signal transmitted to or from a transmitter (such as a UE or a TRP) may be differentiated from signals transmitted to or from other transmitters by using a so-called MA signature. Non-limiting examples of NoMA technologies include sparse code multiple access (SCMA), interleave-grid multiple access (IGMA), multi-user shared access (MUSA), low code rate spreading (LCRS), frequency domain spreading, non-orthogonal coded multiple access (NCMA), pattern division multiple access (PDMA), resource spread multiple access (RSMA), low density spreading with signature vector extension (LDS-SVE), low code rate and signature based shared access (LSSA), non-orthogonal coded access (NOCA), interleave division multiple access (IDMA), repetition division multiple access (RDMA), or group orthogonal coded access (GOCA).

The PSTN 106 may include circuit switched telephone networks for providing plain old telephone service (POTS). The Internet 108 may include a network of computers and subnets (intranets) or both, and incorporate protocols, such as IP, TCP, UDP, and/or the like.

The communication network 104 comprises one or more controlling devices 120 in communication with the TRPs 102 to provide various services such as voice, data, and other services to the UEs 114. The one or more controlling devices 120 of the communication network 104 may also serve as a gateway access between (i) the TRPs 102 or UEs 114 or both, and (ii) other networks (such as the PSTN 106, the Internet 108, and the other networks 110).

FIG. 2 is a simplified schematic diagram of the controlling device 120. As shown, the controlling device 120 comprises at least one processing unit 122 (also denoted “processor”), at least one network interface 124, one or more input/output components or interfaces 126, and at least one memory 128 (also denoted “storage device” hereinafter).

The processing unit 122 is configured for performing various processing operations and may comprise a microprocessor, a microcontroller, a digital signal processor, a field programmable gate array (FPGA), an application specific integrated circuit (ASIC), and/or the like.

The network interface 124 comprises a circuitry for directly or indirectly (that, via one or more intermediate devices) communicating with other devices such as the TRPs 102, the PSTN 106, the Internet 108, and other networks 110 using suitable wired or wireless communication technologies and suitable protocols.

Each input/output component 126 enables interaction with a user or other devices in the communication system 100. Each input/output device 126 may comprise any suitable structure for providing information to or receiving information from a user and may be, for example, a speaker, a microphone, a keypad, a keyboard, a display, a touch screen, and/or the like.

Each memory 128 may comprise any suitable volatile and/or non-volatile storage and retrieval components such as random access memory (RAM), read only memory (ROM), hard disk, optical disc, subscriber identity module (SIM) card, solid-state memory modules, memory stick, secure digital (SD) memory card, and/or the like. The memory 128 may be used for storing instructions executable by the processing unit 122 and data used, generated, or collected by the processing unit 122 and/or the network interface 124. For example, the memory 126 may store software instructions or modules executable by the processing unit 122 for implementing some or all of the functionalities and/or embodiments of the controlling device 120 described herein. The memory 126 may also store coverage information of the TRPs 102 in, for example, a database thereof.

Referring back to FIG. 1, the TRPs 102 may typically comprise a base station and optionally other components such as one or more base station controllers (BSCs), radio network controllers (RNCs), relay nodes, elements, and/or the like. Each TRP 102 (or more specifically the base station thereof) transmits and/or receives wireless signals within a particular geographic region or area (that is, a “cell” or a “coverage area”). A cell may be further partitioned into cell sectors, and a TRP 102 may, for example, employ multiple transceivers to provide service to multiple cell sectors. In some embodiments, there may be established pico or femto cells where the radio access technology supports such. In some embodiments, multiple transceivers may be used for each cell, for example using multiple-input multiple-output (MIMO) technology.

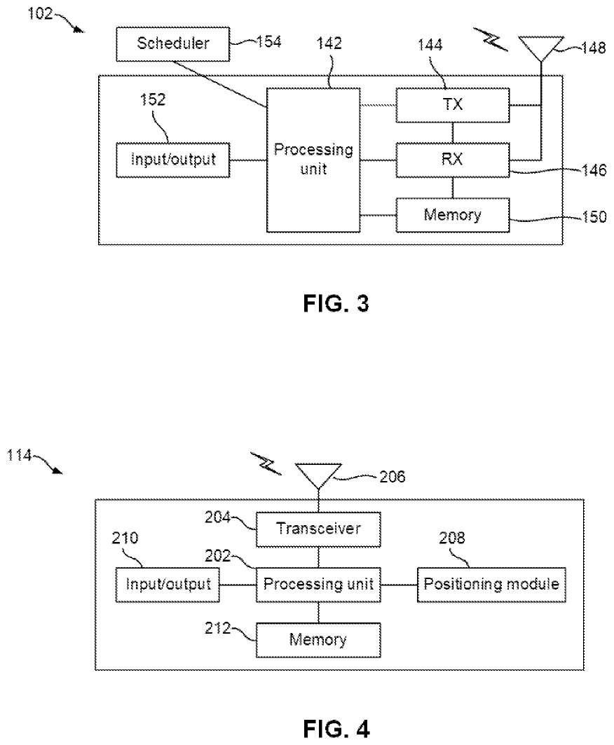

FIG. 3 is a simplified schematic diagram of a TRP 102. As shown, the TRP 102 in these embodiments comprises at least one processing unit 142, at least one transmitter 144, at least one receiver 146, one or more antennas 148, at least one memory 150, and one or more input/output components or interfaces 152. A scheduler 154 may be coupled to the processing unit 142. The scheduler 154 may be included within or operated separately from the TRP 102. Those skilled in the art will appreciate that, in other embodiments and as needed, the TRP 102 may comprise more or less components than the components shown in FIG. 3.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like.

Each transmitter 144 may comprise any suitable structure for generating signals for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 3 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage and retrieval components such as RAM, ROM, hard disk, optical disc, SIM card, solid-state memory modules, memory stick, SD memory card, and/or the like. The memory 150 may be used for storing instructions executable by the processing unit 142 and data used, generated, or collected by the processing unit 142. For example, the memory 150 may store software instructions or modules executable by the processing unit 142 for implementing some or all of the functionalities and/or embodiments of the TRP 102 described herein.

Each input/output component 152 enables interaction with a user or other devices in the system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 1, the TRPs 102 may communicate with the UEs 114 over one or more air interfaces 118 using any suitable wireless communication links such as radio frequency (RF), microwave, infrared (IR), and/or the like. The air interfaces 118 may utilize any suitable channel access methods such as TDMA, FDMA, OFDMA, discrete Fourier transform OFDMA (DFT-OFDMA), SC-FDMA, CDMA, WCDMA, NoMA, and/or the like.

The air interfaces 118 may use any suitable radio access technologies such as universal mobile telecommunication system (UMTS), high speed packet access (HSPA), HSPA+(optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1×, CDMA2000 EV-DO, IS-2000, IS-95, IS-856, global system for mobile communications (GSM), enhanced data rates for GSM evolution (EDGE), GSM EDGE radio access network (GERAN), 5G New Radio (5G NR), standard or non-standard satellite internet access technologies, and/or the like. Moreover, the communication system 100 may use multiple channel access functionality. Of course, other multiple access methods and wireless protocols may be used.

Herein, a UE 114 generally refers to a wireless device that may join the communication system 100 via an initial access procedure. In various embodiments, a UE 114 may be a wireless device used by a human or user (such as a smartphone, a cellphone, a personal digital assistant (PDA), a laptop, a computer, a tablet, a smart watch, a consumer electronics device, and/or the like. A UE 114 may alternatively be a wireless sensor, an Internet-of-things (IoT) device, a robot, a shopping cart, a vehicle, a smart TV, a smart appliance, or the like. Depending on the implementation, the UE 114 may be movable autonomously or under the direct or remote control of a human, or may be positioned at a fixed position. In some embodiments, a UE 114 may be a network device (such as a TRP 102, a wireless transmit/receive unit (WTRU), a mobile station, a fixed or mobile subscriber unit, a machine type communication (MTC) device, a device of the communication network 104, or the like) which is considered as a UE when it is powered on and joins the communication system 100 via an initial access procedure; and then acts as a network device after the initial access procedure is completed. In some embodiments, the UEs 114 may be multimode devices capable of operation according to multiple radio access technologies and incorporate multiple transceivers necessary to support such.

FIG. 4 is a simplified schematic diagram of a UE 114. As shown, the UE 114 comprises at least one processing unit 202, at least one transceiver 204, at least one antenna or network interface controller (NIC) 206, at least one positioning module 208, one or more input/output components 210, and at least one memory 212.

The processing unit 202 is configured for performing various processing operations such as signal coding, data processing, power control, input/output processing, or any other functionalities to enable the UE 114 to join the communication system 100 and operate therein. The processing unit 202 may also be configured to implement some or all of the functionalities and/or embodiments of the UE 114 described in this disclosure. The processing unit 202 may comprise a microprocessor, a microcontroller, a digital signal processor, a FPGA, or an ASIC.

Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like.

The at least one transceiver 204 may be configured for modulating data or other content for transmission by the at least one antenna 206. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning anchors such as navigation satellites, for example, satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. The positioning module 208 may use the transceiver 204 and antenna 206 for communicating with the positioning anchors, or may comprise separate transceiver and antenna for communicating with the positioning anchors.

The one or more input/output components 210 is configured for interaction with a user or other devices in the system 100. Each input/output component 210 may comprise any suitable structure for providing information to or receiving information from a user and may be, for example, a speaker, a microphone, a keypad, a keyboard, a display, a touch screen, a network communication interface, and/or the like.

The at least one memory 212 is configured for storing instructions executable by the processing unit 202 and data used, generated, or collected by the processing unit 202. For example, the memory 212 may store software instructions or modules executable by the processing unit 202 for implementing some or all of the functionalities and/or embodiments of the UE 114 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

Those skilled in the art will appreciate that in various embodiments, the devices or apparatuses described above (such as the TRPs 102 and/or UEs 114) may be implemented as separate devices, or alternatively as components or modules (such as one or more chipsets or circuits) of one or more other suitable devices. Similarly, the devices, apparatuses, components, and/or modules described in greater details below may be implemented as separate devices in some embodiments, or as components or modules (such as one or more chipsets or circuits) of one or more other suitable devices in some other embodiments.

### B. Communication Between TRP and Ues Using Unsourced Random Access

In some embodiments, one or more UEs 114 may communicate with a TRP 102 via one or more feed-forward (FF) links using unsourced random access (URA) for sending data to the TRP 102, and the communication system 100 may be denoted a URA system. While the number of UEs 114 may be very large, at every given time, only a subset of UEs 114 may be active. The UEs 114 usually have no pre-assigned unique user-identifiers, and transmit data signals or packets via the FF links to the TRP in a grant-free manner, without pre-allocation of time or bandwidth resources. Various methods for URA may be found in, for example, References [R2] to [R13] and [R15].

In some embodiments, the TRP 102 uses a feedback (FB) signaling method for notifying the UEs 114 whether or not their transmitted data is successfully received. The TRP 102 generates and broadcasts feedback messages to the UEs 114. The UEs 114 processes the received feedback messages and decides whether retransmission of their data signals is required based on the received feedback messages. The feedback signaling method may effectively reduce the per-user error probability (PUPE) without incurring significant computational complexity at the UEs 114 for processing the feedback messages.

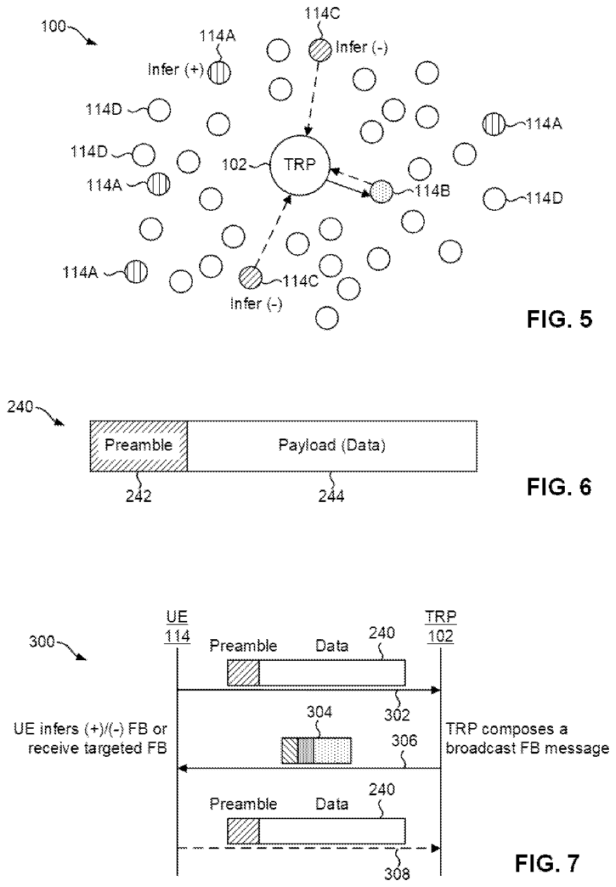

FIG. 5 is a schematic diagram showing the TRP 102 and UEs 114 in the URA system 100 using the feedback signaling method.

As shown, UEs 114A, 114B, and 114C (those shown as circles with shading) are active UEs sending data signals to the TRP 102 using URA and UEs 114D (those shown as circles without shading) are inactive UEs. Those skilled in the art will appreciate that an active UE 114A, 114B, or 114C may later become an inactive UE 114D, and an inactive UE 114D may later become an active UE. The following description only considers the active UEs 114A, 114B, and 114C.

Based on the data reception status, The TRP 102 broadcasts a feedback message to all UEs 114A to 114C. The broadcasted feedback message is structured in a way that the majority of the UEs 114A to 114C may infer positive or negative feedbacks. In some embodiments, the feedback message comprises a targeted feedback (FB) section which may include a small number of specific or “personalized” feedback UE acknowledgments (for example, a superposition or a combination of a small number of UE preambles). Therefore, the decoding of the targeted FB section at UEs 114A to 114C may be greatly simplified. Moreover, in some embodiments, the broadcasted feedback message may be further structured in a way that the majority of the UEs 114A to 114C may infer positive or negative feedbacks from the first part of the feedback message without decoding the entire feedback message.

In the example shown in FIG. 5, the data sent from UEs 114A to the TRP 102 have been correctly detected (or received) and decoded by the TRP 102 (and thus UEs 114A are denoted correctly detected/decoded UEs). Thus, the data transmissions from the correctly detected/decoded UEs 114A to the TRP 102 are successful and no retransmission is required. Most of the correctly detected/decoded UEs 114A may infer positive feedback from the received feedback message.

On the other hand, the data signal sent from the UE 114B to the TRP 102 is correctly detected (or received) but is not correctly decoded (or cannot be decoded) by the TRP 102 (and thus the UE 114B is denoted an undecoded UE), and the data signals sent from UEs 114C to the TRP 102 are not detected (or not received) by the TRP 102 (and thus the UEs 114C are denoted missed UEs). Thus, the data transmissions from the undecoded UEs 114B and missed UEs 114C to the TRP 102 failed. Most of the undecoded UEs 114B and missed UEs 114C may infer negative feedback from the received feedback message. The undecoded UEs 114B and missed UEs 114C then schedule data retransmission.

The details of the feedback signaling method are now described.

As those skilled in the art will appreciate, A UE 114 may send data to a TRP 102 as data packets (denoted “UE packets”) via the FF link therebetween. As shown in FIG. 6, a UE packet 240 comprises a preamble 242 and a payload 244 carrying the data to be sent to the TRP 102.

The preamble 242 is selected by the UE 114 from a common preamble pool having a plurality of preamble candidates and is used for packet detection at the TRP 102. The preamble pool is common to all UEs 114 and each UE maintains a copy of the common preamble pool. The TRP 102 also maintains a copy of the common preamble pool.

When the TRP 102 receives a UE packet 240, the TRP 102 first detects the preamble 242 of the UE packet 240 and then decodes data from the payload 244 of the UE packet 240. As those skill in the art will appreciate, although there are no permanent UE identifiers (IDs) in the URA system 100 using URA, the FF-link preambles 242 (which may carry part of the transmitted data) may be considered temporary UE IDs.

FIG. 7 is a sequence diagram showing a process 300 performed by one or more UEs 114 and a TRP 102 for data transmissions from the UEs 114 to the TRP 102 using URA. As shown, the UEs 114 send packets 240 to the TRP 102 via the FF links therebetween (step 302).

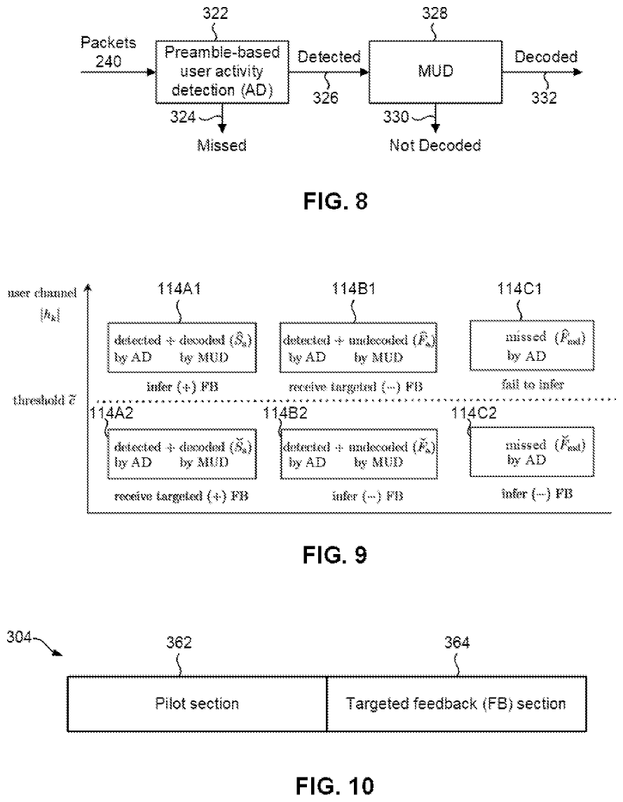

The TRP 102 receives the packets 240 from the UEs 114. As shown in FIG. 8, the TRP 102 performs preamble detection 322 using for example, activity detection (AD) (which may use for example, an approximate message passing (AMP) method for threshold-based active detection), to determine which preambles are active and to perform user channel estimation. Herein, a user channel refers to the wireless channel between the TRP 102 and a UE 114.

If the preamble detection 322 is unsuccessful (that is, the branch “missed” 324 shown in FIG. 8), the packet 240 is classified as a missed packet and the (unknown) UE 114 that sends this packet 240 (denoted the “sender UE” hereinafter) is classified as a missed (or undetected) UE 114C.

If the preamble detection 322 is successful (that is, the branch “detected” 326 shown in FIG. 8), the TRP 102 then performs a multi-user detection (MUD) 328 to extract the data from the packet payloads 244. If the MUD 328 is unsuccessful (that is, the branch “not decoded” 330 shown in FIG. 8), the packet 240 is classified as an undecoded packet and the sender UE 114 is classified as an undecoded UE 114B.

If the MUD 328 is successful (that is, the branch “decoded” 332 shown in FIG. 8), the TRP 102 decodes the extracted data and the sender UE 114 is classified as a correctly detected/decoded UE 114A.

Thus, based on the successfulness of the AD 322 and MUD 328, the packets at the TRP 102 may be classified as missed or undetected (that is, unsuccessful) packets, detected but undecoded or failed to decode (that is, unsuccessful) packets, and decoded (that is, successful) packets, and the sender UEs may be accordingly classified as missed UEs 114C, undecoded UEs 114B, and correctly detected/decoded UEs 114A. Referring back to FIG. 7, the TRP 102 composes or generates a feedback message 304 and broadcasts the feedback message 304 to the UEs 114 (step 306). After receiving the feedback message 304, each UE 114 infers or detects a positive or negative feedback. The UEs 114B and 114C that infers negative feedback then retransmit their packets 240 to the TRP 102 (step 308).

In some embodiments, the TRP 102 uses one or more thresholds to classify UEs 114 into a plurality of groups based on the characteristics of the channels between the TRP 102 and the UEs 114, such as the values of their channel coefficients. Such a UE classification may facilitate the identification of UE groups that require targeted feedback and UE groups that need to process the entire feedback message. Other UE groups may infer the positive or negative feedback based on the knowledge of their channel characteristics relative to the one or more thresholds.

FIG. 9 shows an example of UE classification using a single threshold \tilde{c} after the TRP 102 finishes processing of the received packets 240. In this example, the UE classification is based on the UEs' channel amplitudes and the threshold \tilde{c} is an amplitude threshold.

As shown in FIG. 9, classifying the UEs based on their channel amplitudes using the threshold \tilde{c} may result in six (6) UE groups:
correctly detected/decoded UEs 114A1 above the threshold \tilde{c};
correctly detected/decoded UEs 114A2 below the threshold \tilde{c};
undecoded UEs 114B1 above the threshold \tilde{c};
undecoded UEs 114B2 below the threshold \tilde{c};
missed UEs 114C1 above the threshold \tilde{c}; and
missed UEs 114C2 below the threshold \tilde{c}.

Those skilled in the art will appreciate that the probability that a UE 114 becomes a missed UEs 114C1 above the threshold \tilde{c} is usually very small. Therefore, the methods disclosed herein may allow some or all of the missed UEs 114C1 above the threshold \tilde{c} to be temporarily or permanently lost, which may only cause a small feedback error that may be affordable in, for example, URA.

Based on the UE classification with respect to threshold \tilde{c}, the TRP 102 generates the feedback message or packet. As shown in FIG. 10, the feedback message comprises:
a pilot section 362 for facilitating channel estimation at the UEs 114 and delivering the thresholds to the UEs 114; and
a targeted feedback (FB) section 364 comprising a superposition of the preambles of the UEs 114 designated to receive targeted feedbacks; each preamble may be power-scaled.

As described above, the generated feedback message is broadcast to all UEs 114.

After receiving the feedback message, each UE 114 performs a feedback detection process. More specifically, each UE 114 first uses the pilot section 362 to estimate its channel between the UE 114 and the TRP 102, and retrieves the threshold \tilde{c} from the pilot section 362. As will be described in more detail later, each UE 114 may infer positive or negative feedback at least based on the relationship between the amplitude of the channel coefficient and the threshold \tilde{c}, and, if needed, further based on the information obtained from the targeted FB section 364.

The UEs that need to process the targeted FB section 364 may process the targeted FB section 364 and recover the feedback directed to them (positive or negative), or may infer the feedback information from the fact that such specific or “personalized” feedback directed to them was absent.

By using the feedback message and the feedback detection process, the number of specific or “personalized” feedback messages and the number of UEs processing them may be reduced thereby reducing the UE's computational complexity and power consumption.

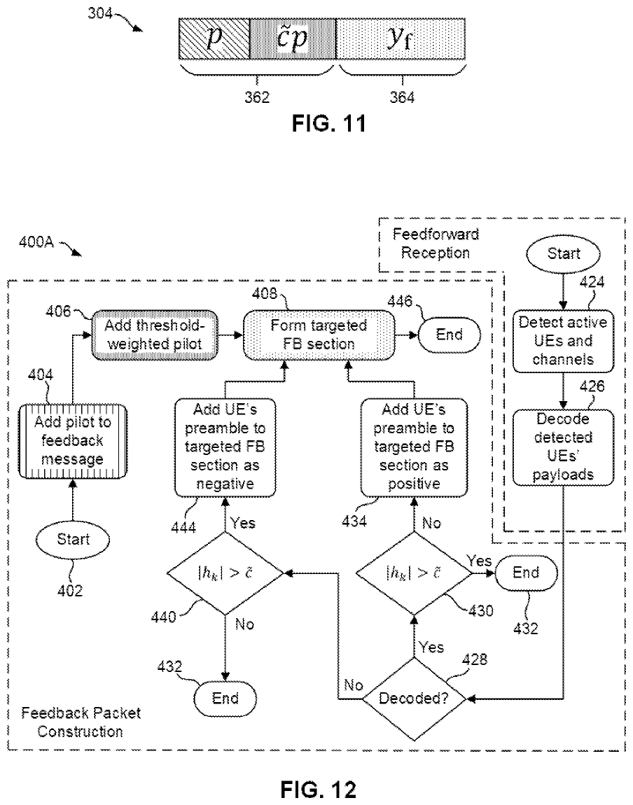

FIG. 11 shows the structure of a feedback message 304 according to some embodiments of this disclosure. In these embodiments, the pilot section 362 of the feedback message 304 comprises a pilot signal p and a threshold-weighted pilot signal \tilde{c}p. The pilot signal p may be used by the UEs 114 to estimate their channels. The threshold-weighted pilot signal \tilde{c}p encodes the threshold \tilde{c} (for example, by multiplying the pilot signal p by the threshold \tilde{c}) to allow the UEs 114 to estimate the threshold value based on the pilot signal p (for example, by comparing the threshold-weighted pilot signal \tilde{c}p with the pilot signal p). The targeted FB section 364, which is also represented using the symbol y_{f}, is given by

$${y}_{f} = {\sum }_{k ∈ {\hat{F}}_{a}} ( - 1 ) {\hat{h}}_{k}^{*} {a}_{v ( k )} + {\sum }_{k ∈ {{S}^{⋁}}_{a}} ( + 1 ) {\hat{h}}_{k}^{*} {a}_{v ( k )} \qquad ( 1 )$$

where \hat{F}ₐ represents the UEs 114B1, Šₐ represents the UEs 114A2 (see FIG. 9), aᵥ₍ₖ₎ represents the preamble of a UE, ĥₖ represents the estimated channel response, ĥₖ* represents the conjugate of ĥₖ (thus, ĥₖ*aᵥ₍ₖ₎ represents the weighted UE preamble (weighted by the estimated channel response)), (−1) represents the negative feedback with (−1)ĥₖ*aᵥ₍ₖ₎ representing associating the UE preamble ĥₖ*aᵥ₍ₖ₎ with a negative feedback (for example, multiplying the weighted UE preamble with (−1) or changing the sign thereof; other methods of associating the UE preamble with the negative feedback also readily available), (+1) represents the positive feedback with (+1)ĥₖ*aᵥ₍ₖ₎ representing associating the weighted UE preamble ĥₖ*aᵥ₍ₖ₎ with a positive feedback (for example, keeping the sign of the weighted UE preamble unchanged; other methods of associating the UE preamble with the positive feedback also readily available), and symbols “Σ” and “+” represent combination or superposition.

In some embodiments, the targeted FB section 364, which is also represented using the symbol y_{f}, may alternatively be written as:

$${y}_{f} = \qquad ( 2 )$$

$${\sum }_{k ∈ {F}_{a} ⋂ \vert {\hat{h}}_{k} \vert > \tilde{c}} ( - T ) \frac{{\hat{h}}_{k}^{*}}{{\vert {\hat{h}}_{k}^{*} \vert}^{2}} {a}_{k} + {\sum }_{k ∈ {F}_{a} ⋂ \vert {\hat{h}}_{k} \vert \leq \tilde{c}} ( - 1 ) \frac{{\hat{h}}_{k}^{*}}{{\vert {\hat{h}}_{k}^{*} \vert}^{2}} {a}_{k} + {\sum }_{k ∈ {{S}^{⋁}}_{a}} ( + 1 ) \frac{{\hat{h}}_{k}^{*}}{{\vert {\hat{h}}_{k}^{*} \vert}^{2}} {a}_{k}$$

In these embodiments, instead of UE 114 to perform channel estimation and comparison of its channel amplitude |hₖ| with the threshold \tilde{c}, the TRP 102 performs channel measurement for UEs 114B (including UEs 114B1 of the set Fₐ), for which the corresponding preambles are detected but the data is not decoded successfully.

The channel measurement is based on obtaining the received channel gain over each preamble and separating the UEs 114B in two groups:
UEs 114B1 whose received channel amplitude |hₖ| (estimated at the TRP 102) is above the threshold \tilde{c} (represented by k∈Fₐ∩|ĥₖ|>\tilde{c} in Equation (2), and
UEs 114B2 whose received channel amplitude |ĥₖ| is below the threshold \tilde{c} (represented by k∈Fₐ∩|ĥₖ|≤\tilde{c} in Equation (2).

### Then,

for UEs 114B1 (wherein the corresponding channel amplitude is above \tilde{c}), the TRP 102 uses the terms ĥₖ*aₖ scaled by a pre-defined constant value (−T) (that is, the first term in Equation (2)) and also by

$$\frac{1}{{\vert {\hat{h}}_{k}^{*} \vert}^{2}} ,$$

which is a value different than one (1);
for UEs 114B2 (wherein the corresponding channel power gain is below \tilde{c}), the TRP 102 uses the terms ĥₖ*aᵥ scaled by (−1) (that is, the second term in Equation (2)) and also by

$$\frac{1}{{\vert {\hat{h}}_{k}^{*} \vert}^{2}} ;$$

and
for UEs 114A2 of the set Šₐ who are both successfully detected and decoded and their channel power is below cτ, the TRP 102 uses the terms ĥₖ*aₖ scaled by (+1) (that is, the third term in Equation (2)) and also by

$$\frac{1}{{\vert {\hat{h}}_{k}^{*} \vert}^{2}} .$$

By using the scaling factor of

$$\frac{1}{{\vert {\hat{h}}_{k}^{*} \vert}^{2}}$$

in these embodiments, the aggregated channel amplitudes of the UEs 114B1, 114B2, and 114A2 in Equation (2) becomes one and therefore, Each of the UEs 114B1, 114B2, and 114A2 may compare the received signal amplitude with the pre-determined threshold without requiring to perform any channel estimation. Thus, in these embodiments, the channel estimation burden is put at the TRP side and UEs may not need to perform any channel estimation. In addition, to enable UEs to distinguish between the above-described states (that is, UEs 114B1, 114B2, and 114A2), T may be chosen to be different than one (1) and may be preferably greater than one (1).

With reference to FIG. 9, it can be seen that the targeted FB section 364 combines the preambles of UEs 114A2 (wherein the TRP 102 correctly detected and decoded the data packets thereof, and the amplitudes of the channels between the TRP 102 and the UEs 114A2 are below the threshold \tilde{c}) and the preambles of UEs 114B1 (wherein the TRP 102 detected the data packets thereof but cannot successfully decoded the data packets, and the amplitudes of the channels between the TRP 102 and the UEs 114B1 are above the threshold \tilde{c}), wherein the preambles of UEs 114A2 and 114B1 are marked or associated with respective feedback types (that is, the preambles of UEs 114A2 are marked as positive feedback, and the preambles of UEs 114B1 are marked as negative feedback), for example, by maintaining a sign bit of the preamble for representing the positive feedback or flipping the sign bit thereof to (+1) for representing the negative feedback, or by associating a feedback-type signal to the preamble. The preambles of other UEs such as the UEs 114A1, 114B2, 114C1, and 114C2 are not required in the targeted FB section 364. As a result and as will be described in more detail later, the density of the targeted FB section 364 (in other words, the number of preambles in the targeted FB section 364) is reduced and the computational cost of processing the targeted FB section 364 is thus reduced.

FIG. 12 is a flowchart showing a process 400A executed by the TRP 102 for generating a feedback message 304 using a single threshold \tilde{c}, according to some embodiments of this disclosure. After the process 400A starts (step 402), the TRP 102 adds the pilot signal p into the feedback message 304 (step 404) and adds the threshold-weighted pilot signal \tilde{c}p into the feedback message 304 (step 406). The TRP 102 then generates the targeted FB section 364.

To generate the targeted FB section 364, the TRP 102 detects active users (that is, active UEs 114) and the channels between the TRP 102 and the detected active users 114 (step 424). At step 426, the TRP 406 detects data packets 240 sent from the active users 114 and, if a data packet 240 is successfully detected or received, decodes the payload 244 thereof.

For each detected data packet 240, the TRP 102 checks if the payload 244 is correctly or successfully decoded (step 428). If the payload 244 is correctly decoded (the “Yes” branch of step 428), the TRP 102 further checks if the amplitude |hₖ| of the channel between the corresponding UE and the TRP 102 is greater than the threshold \tilde{c} (step 430). If the amplitude |hₖ| of the channel between the corresponding UE and the TRP 102 is greater than the threshold \tilde{c} (the “Yes” branch of step 430), no information of this UE is included in the targeted FB section 364 of the feedback message 304. The processing related to this UE is then ended (step 432) and the TRP 102 starts to process another UE (from step 428).

If at step 430, the amplitude |hₖ| of the channel between the corresponding UE and the TRP 102 is not greater than the threshold \tilde{c} (the “No” branch of step 430), the TRP 102 marks the UE's preamble as positive feedback (for example, associating the UE's preamble with a positive indicator) and adds the UE's preamble to the targeted FB section 364 (step 434) to form the targeted FB section 364 of the feedback message 304 (step 408). The processing of this UE is then ended (step 446) and the TRP 102 starts to process another UE (from step 428).

If at step 428, the payload 244 is not correctly decoded (the “No” branch of step 428), the TRP 102 further checks if the amplitude |hₖ| of the channel between the corresponding UE and the TRP 102 is greater than the threshold \tilde{c} (step 440). If the amplitude |hₖ| of the channel between the corresponding UE and the TRP 102 is not greater than the threshold \tilde{c} (the “No” branch of step 440), no information of this UE is included in the targeted FB section 364 of the feedback message 304. The processing related to this UE is then ended (step 432) and the TRP 102 starts to process another UE (from step 428).

If at step 440, the amplitude |hₖ| of the channel between the corresponding UE and the TRP 102 is greater than the threshold \tilde{c} (the “Yes” branch of step 440), the TRP 102 marks the UE's preamble as negative feedback (for example, associating the UE's preamble with a negative indicator) and adds the UE's preamble to the targeted FB section 364 (step 444) and forms the feedback message 304. The processing of this UE is then ended (step 446) and the TRP 102 starts to process another UE (from step 428).

After all detected UEs are processed, the feedback message is then formed and the process 400A ends (step 446). Then, the feedback message may be broadcast to all UEs 114.

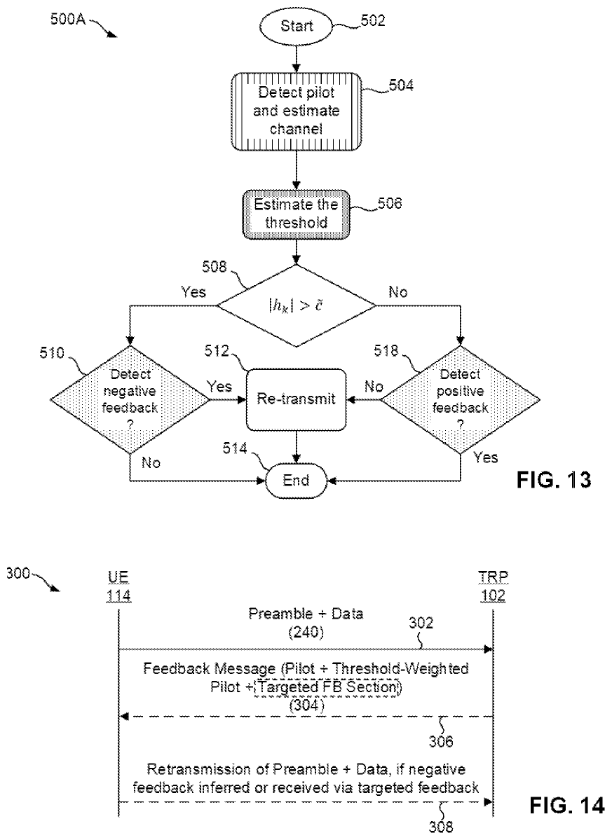

FIG. 13 is a flowchart showing a feedback-detection process 500A performed by a UE 114, according to some embodiments of this disclosure. The process 500A starts (step 502) when the UE 114 receives the feedback message 304 generated using the process 400A shown in FIG. 12.

At step 504, the UE 114 detects the pilot signal from the received feedback message and estimates the channel between the UE 114 and the TRP 102. At step 506, the UE 114 also estimates the threshold \tilde{c}.

The UE 114 then checks if the amplitude |hₖ| of the estimated channel is greater than the threshold \tilde{c} (step 508). If the amplitude |hₖ| of the estimated channel is greater than the threshold \tilde{c} (the “Yes” branch of step 508), the UE 114 detects if its preamble is in the targeted FB section 364 and is marked as negative feedback (step 510). If the UE's preamble is not in the targeted FB section 364 or is not marked as negative feedback (the “No” branch of step 510), no retransmission is required and the process 500A then ends (step 514).

If at step 510, the UE's preamble is in the targeted FB section 364 and is marked as negative feedback (the “Yes” branch of step 510), the UE 114 then determines that the data transmission to the TRP 102 has failed and schedules retransmission (step 512). The process 500A then ends (step 514).

If at step 508, the amplitude |hₖ| of the estimated channel is not greater than the threshold \tilde{c} (the “No” branch of step 508), the UE 114 detects if its preamble is in the targeted FB section 364 and is marked as positive feedback (step 518). If the UE's preamble is in the targeted FB section 364 and is marked as positive feedback (the “Yes” branch of step 510), the process 500A then ends (step 514).

If at step 518, the UE's preamble is not in the targeted FB section 364 or is not marked as negative feedback (the “No” branch of step 518), the UE 114 then determines that the data transmission to the TRP 102 has failed and schedules retransmission (step 512). The process 500A then ends (step 514).

By using the feedback message 304 generated using the process 400A shown in FIG. 12 and the feedback-detection process 500A shown in FIG. 13, UEs 114A1, 114C1, 114B2, and 114C2 may infer the feedback without a targeted feedback message. Thus, the number of specific or “personalized” feedback messages and the number of UEs processing them may be reduced thereby reducing the UE's computational complexity and power consumption for processing the feedback. The per-user probability of feedback error (that is, the relative number of UEs that received wrong feedback) is also reduced. For example, the per-user probability of feedback error of the process 400A is much lower than that of the “negative-only” feedback method described later.

Moreover, the complexity of processing the targeted FB section by the UE 114 is much lower compared to the “positive-only” feedback method described later and therefore, active UEs may employ simple correlator to detect their preambles. Moreover, even partial correlation to the signatures may be sufficient.

FIG. 14 is a sequence diagram showing more details of the process 300 shown in FIG. 7 with dynamic signaling exchange between the UE 114 and the TRP 102, according to some embodiments of this disclosure.

As shown, the UEs 114 send packets 240 (comprising the UE's preamble and data) to the TRP 102 via the FF links therebetween (step 302).

The TRP 102 receives the packets 240 from the UEs 114 and performs preamble detection to determine which preambles are active and to perform user channel estimation. Based on the preamble detection, the TRP 102 classifies the UE 114 as a correctly detected/decoded UE 114A, an undecoded UE 114B, or a missed UE 114C. The TRP 102 then composes or generates a feedback message 304 using the process 400A shown in FIG. 12, and broadcasts the feedback message 304 to the UEs 114 (step 306). After receiving the feedback message 304, each UE 114 infers a positive or negative feedback. As described above, the UEs 114 that cannot successfully infer the feedback may individually receive specific or targeted or “personalized” feedbacks from the TRP 102. The UEs 114B and 114C that infers negative feedback then retransmit their packets 240 to the TRP 102 (step 308).

In some embodiments, the first part (that is, the pilot signal p) of the feedback message 304 may be broadcasted through higher layer signaling such as radio resource control (RRC), medium access control (MAC)-control element (MAC-CE), and/or the like, for suitable arrangement of time/frequency resource for the pilot and the waveform/numerology configurations for the pilot signal.

In some embodiments, the second part (that is, the threshold-weighted pilot signal \tilde{c}p, or in some embodiments, the weighted value) of the feedback message 304 may be transmitted through dynamic signaling such as downlink control information (DCI), higher layer signaling such as RRC or MAC-CE, and/or the like.

The time duration of the threshold-weighted pilot signal \tilde{c}p may be communicated through dynamic signaling such as DCI (in case the ratio between threshold-weighted pilot signal \tilde{c}p and the pilot signal p needs adjustment), higher layer signaling such as RRC or MAC-CE, and/or the like.

In some embodiments, the third part y_{f} (that is, the targeted FB section 364) of the feedback message 304 may be transmitted through higher layer signaling such as RRC or MAC-CE for suitable arrangement of time/frequency resources for the pilot and the waveform/numerology configurations therefor.

Thus, those skilled in the art will appreciate that, by using the above-described feedback message 304 and processes 400A and 500A, the distribution of the threshold \tilde{c} may be accomplished via an existing network mechanism and with reduced overhead. Waveform numerology and pilot composition may also be distributed according to the network dynamics.

With reference again to FIG. 9 and as described above, in these embodiments, the targeted FB section 364 combines the preambles of UEs 114A2 (marked as positive feedback) and 114B1 (marked as negative feedback). The preambles of other UEs such as the UEs 114A1, 114B2, 114C1, and 114C2 are not required in the targeted FB section 364. As a result, the density of the targeted FB section 364 is reduced and the computational cost of processing the targeted FB section 364 is thus reduced.

As those skilled in the art will appreciate, the reduction of the density of the targeted FB section 364 and consequently the reduction of the computational cost of processing the targeted FB section 364 depend on suitable selection of the threshold \tilde{c}.

In some embodiments, the threshold \tilde{c} may be selected based on channel estimation conducted at an initialization stage of the system 100, historical channel estimation performed by the UEs 114 using the process 500A shown in FIG. 13, and/or the like.

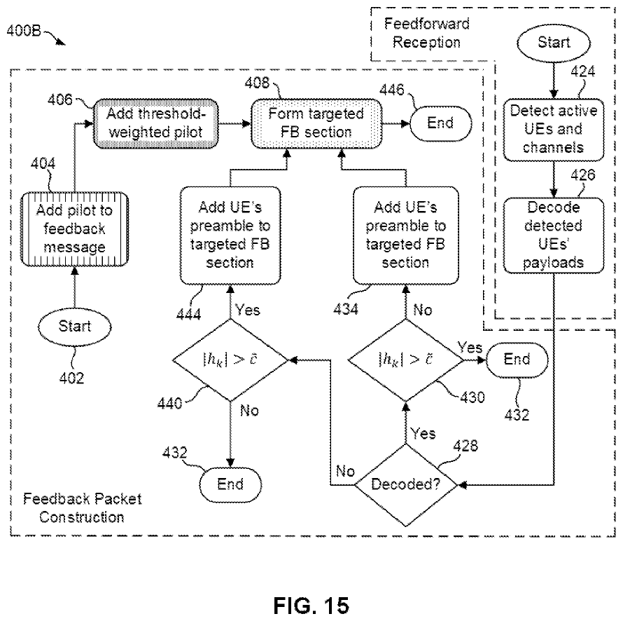

FIG. 15 is a flowchart showing a process 400B executed by the TRP 102 for generating a feedback message 304 using a single threshold \tilde{c}, according to some embodiments of this disclosure. The process 400B is similar to the process 400A shown in FIG. 12 except that in the process 400B, (1) at step 434, the UE's preamble is added to the targeted FB section 364 without marking it as positive feedback, and (2) at step 444, the UE's preamble is added to the targeted FB section 364 without marking it as negative feedback.

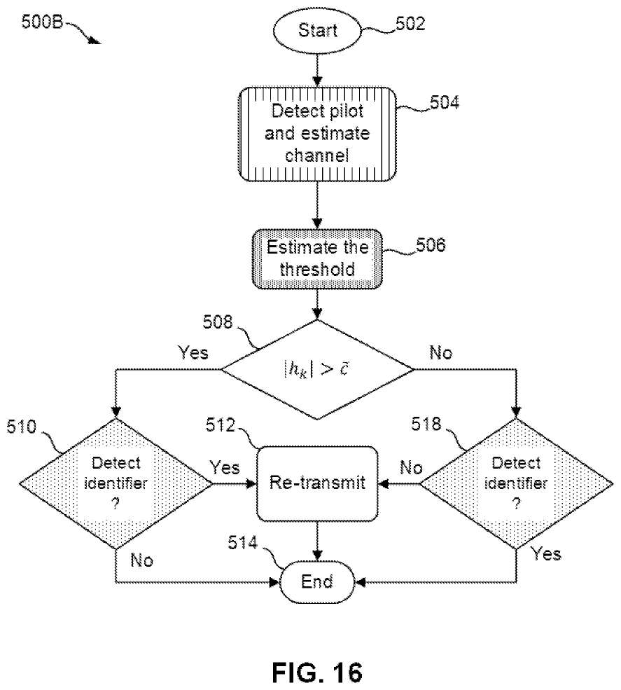

Accordingly, FIG. 16 is a flowchart showing a feedback-detection process 500B performed by a UE 114 for processing the feedback message 304 generated by the TRP 102 using the process 400B shown in FIG. 15, according to some embodiments of this disclosure. The process 500B is similar to the process 500A shown in FIG. 13 except that in the process 500B, (1) at step 518, the UE 114 detects if its preamble is in the targeted FB section 364 without checking whether it is marked as positive feedback, and (2) at step 510, the UE 114 detects if its preamble is in the targeted FB section 364 without checking whether it is marked as negative feedback.

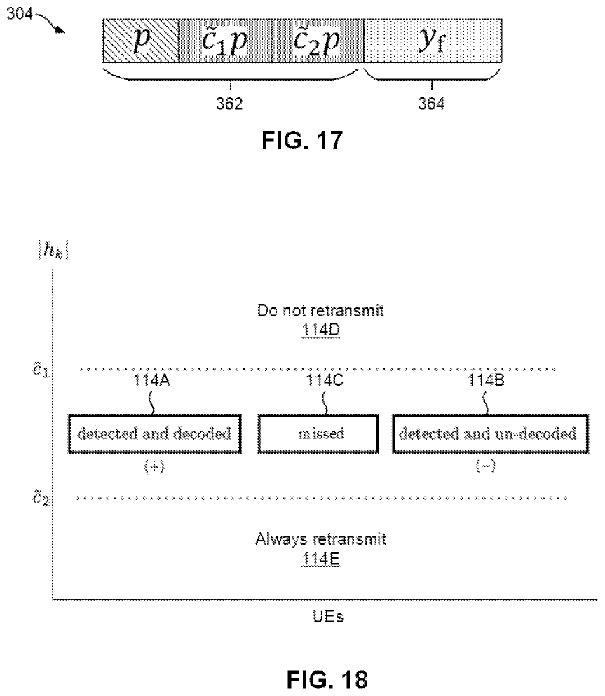

Those skilled in the art will appreciate that, in various embodiments, more than one thresholds may be used. For example, in some embodiments as shown in FIG. 17, two thresholds \tilde{c}₁ and \tilde{c}₂ (for example, \tilde{c}₁ and \tilde{c}₂ are amplitude thresholds with \tilde{c}₁>\tilde{c}₂) are used and the pilot section 362 of the feedback message 304 in these embodiments comprises a pilot signal p, a first threshold-weighted pilot signal \tilde{c}₁p encoding the first threshold \tilde{c}₁ and a second threshold-weighted pilot signal \tilde{c}₂p encoding the second threshold \tilde{c}₂ (such that the UE 114 may estimate the first/second thresholds based on the pilot signal p, for example, by comparing the first/second threshold-weighted pilot signal with the pilot signal p).

By using the two thresholds \tilde{c}₁ and \tilde{c}₂, the TRP 102 may classify the UEs 114 into three categories based on estimated channels amplitudes. As shown in FIG. 18, the TRP 102 may classify the UEs that have channel amplitudes |hₖ| greater than the first threshold \tilde{c}i as no-retransmit UEs 114D that do not need to retransmit their data packets, and the UEs that have channel amplitudes |hₖ| smaller than the second threshold \tilde{c}₂ as always-retransmit UEs 114E that will need to retransmit their data packets. The TRP 102 may classify the UEs that have channel amplitudes |hₖ| between the two thresholds \tilde{c}₁ and \tilde{c}₂ as the correctly detected/decoded UEs 114A if their data packets are correctly detected and decoded, the undecoded UEs 114B if their data packets are correctly detected but cannot be decoded, and the missed UEs 114C if their data packets are not detected. The TRP 102 forms a broadcast feedback message with a customized targeted FB section 364 for UEs 114A and 114B.

Accordingly, the UEs 114 may compare their channel amplitudes |hₖ| with the first and second thresholds \tilde{c}₁ and \tilde{c}₂. The UEs with channel amplitudes |hₖ| greater than the first threshold \tilde{c}₁ (that is, the no-retransmit UEs 114D) may easily infer positive feedback based on the comparison and thus do not re-transmit their data packets. The UEs with channel amplitudes |hₖ| smaller than the second threshold C2 (that is, the always-retransmit UEs 114E) may easily infer negative feedback based on the comparison and thus re-transmit their data packets.

The UEs with channel amplitudes |hₖ| between the two thresholds \tilde{c}₁ and \tilde{c}₂ may decode the targeted FB section 364 wherein the UEs 114A may identify their preambles from the targeted FB section 364 and infer positive feedback (this do not need to retransmit their data packets), and the UEs 114B and 114C will not identify their preambles from the targeted FB section 364 and will retransmit their data packets.

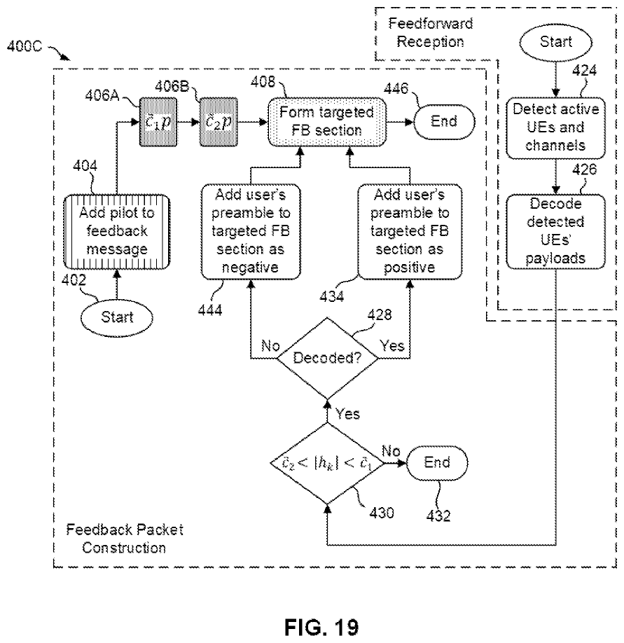

FIG. 19 is a flowchart showing a process 400C in these embodiments executed by the TRP 102 for generating a feedback message 304 using two thresholds \tilde{c}₁ and \tilde{c}₂. The process 400B is similar to the process 400A shown in FIG. 12. Therefore, in the description below, similar steps are identified using same reference numerals.

After the process 400C starts (step 402), the TRP 102 adds the pilot signal p into the feedback message 304 (step 404) and adds the threshold-weighted pilot signals \tilde{c}₁p and \tilde{c}₂p into the feedback message 304 (steps 406A and 406B). The TRP 102 then generates the targeted FB section 364.

To generate the targeted FB section 364, the TRP 102 detects active users (that is, active UEs 114) and the channels between the TRP 102 and the detected active users 114 (step 424). At step 426, the TRP 406 detects data packets 240 sent from the active users 114 and, if a data packet 240 is successfully detected or received, decodes the payload 244 thereof.

For each detected data packet 240, the TRP 102 checks if the amplitude |hₖ| of the channel between the corresponding UE and the TRP 102 is smaller than the first threshold \tilde{c}₁ and greater than the second threshold \tilde{c}₂, that is, \tilde{c}₂<|hₖ|<\tilde{c}₁ (step 430). If the amplitude |hₖ| of the channel between the corresponding UE and the TRP 102 is either smaller than the second threshold \tilde{c}₂ or greater than the first threshold \tilde{c}₁ (the “No” branch of step 430), no information of this UE is included in the targeted FB section 364 of the feedback message 304. The processing related to this UE is then ended (step 432) and the TRP 102 starts to process another UE (from step 430).

If it is determined at step 430 that \tilde{c}₂<|hₖ|<\tilde{c}₁, (the “Yes” branch of step 430), the TRP 102 then checks if the payload 244 is correctly or successfully decoded (step 428). If the payload 244 is correctly decoded (the “Yes” branch of step 428), the TRP 102 marks the UE's preamble as positive feedback and adds the UE's preamble to the targeted FB section 364 (step 434) to form the targeted FB section 364 of the feedback message 304. The processing of this UE is then ended (step 446) and the TRP 102 starts to process another UE (from step 430).

If at step 428, the payload 244 is not correctly decoded (the “No” branch of step 428), the TRP 102 marks the UE's preamble as negative feedback and adds the UE's preamble to the feedback section 364 (step 444) to form the targeted FB section 364 of the feedback message 304. The processing of this UE is then ended (step 446) and the TRP 102 starts to process another UE (from step 430).

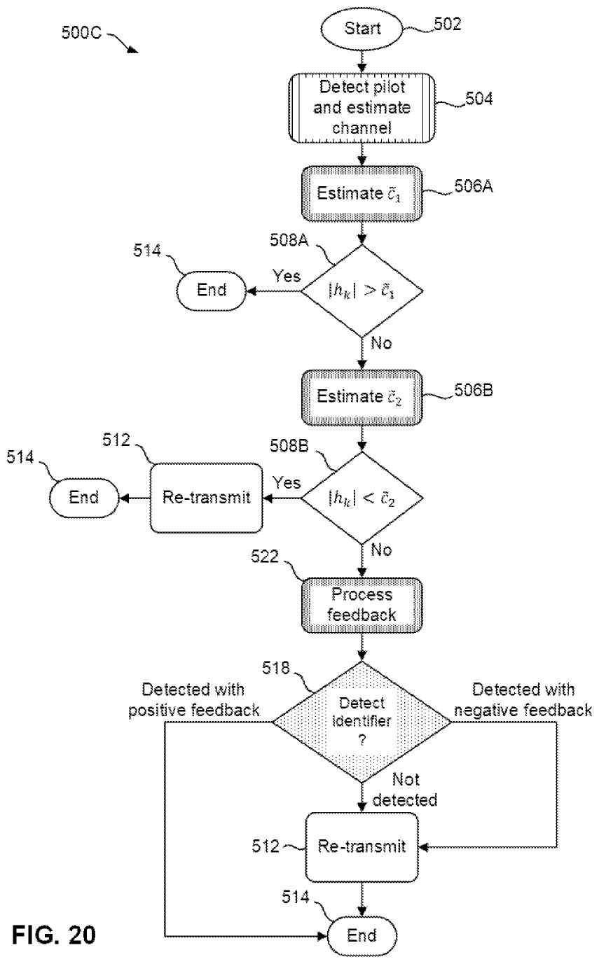

FIG. 20 is a flowchart showing a feedback-detection process 500C performed by a UE 114 for processing the feedback message generated by the TRP 102 using the process 400C shown in FIG. 19, according to some embodiments of this disclosure. The process 500C is similar to the process 500A shown in FIG. 13. Therefore, in the description below, similar steps are identified using same reference numerals.

The process 500C starts (step 502) when the UE 114 receives the feedback message 304 generated using the process 400C shown in FIG. 19.

At step 504, the UE 114 detects the pilot signal from the received feedback message and estimates the channel between the UE 114 and the TRP 102. At step 506A, the UE 114 estimates the first threshold \tilde{c}₁.

The UE 114 then checks if the amplitude |hₖ| of the estimated channel is greater than the first threshold 1 (step 508A). If the amplitude |hₖ| of the estimated channel is greater than the threshold \tilde{c}₁ (the “Yes” branch of step 508A), no retransmission is required and the process 500C ends (step 514).

If at step 508A, the amplitude |hₖ| of the estimated channel is not greater than the first threshold \tilde{c}₁ (the “No” branch of step 508A), the UE 114 estimates the second threshold \tilde{c}₂ (step 506B).

The UE 114 then checks if the amplitude |hₖ| of the estimated channel is smaller than the second threshold \tilde{c}₂ (step 508B). If the amplitude |hₖ| of the estimated channel is smaller than the second threshold \tilde{c}₂ (the “Yes” branch of step 508B), meaning that retransmission is required, the UE 114 then retransmits the data packet (step 512) and the process 500C ends (step 514).

If at step 508B, the amplitude |hₖ| of the estimated channel is not smaller than the second threshold \tilde{c}₂ (the “No” branch of step 508B), the UE 114 then processes the targeted FB section 364 of the feedback message 304 (step 522) and checks if its preamble is detected (step 518). If the UE 114 detects its preamble marked with positive feedback in the targeted FB section 364 (the “Detected with positive feedback” branch of step 518), no retransmission is required and the process 500C ends (step 514).

If at step 518, the UE 114 detects its preamble marked with negative feedback in the targeted FB section 364 (the “Detected with negative feedback” branch of step 518), or the UE 114 does not detect its preamble in the targeted FB section 364 (the “Not detected” branch of step 518), the UE 114 then retransmits the data packet (step 512) and the process 500C ends (step 514).

By using the process 500C, each UE 114 only decodes the targeted FB section 364 of the feedback message 304 when needed (that is, after confirming that its channel amplitude |hₖ| is between the two thresholds \tilde{c}₁ and \tilde{c}₂), thereby saving the computational cost and power of the UEs.

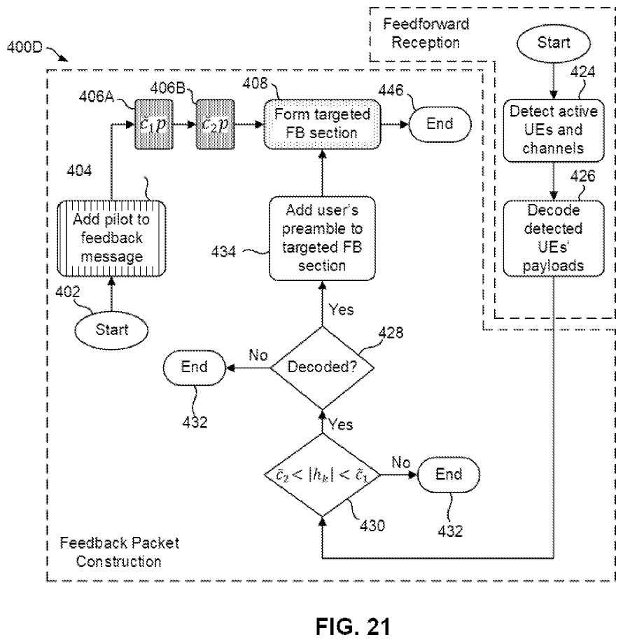

FIG. 21 is a flowchart showing a process 400D executed by the TRP 102 for generating a feedback message 304 using two thresholds \tilde{c}₁ and \tilde{c}₂, according to some embodiments of this disclosure. The process 400D is similar to the process 400C shown in FIG. 19 except the following:

At step 428, if the payload 244 is not correctly decoded (the “No” branch of step 428), no information of this UE is included in the targeted FB section 364 of the feedback message 304. The processing related to this UE is then ended (step 432) and the TRP 102 starts to process another UE (from step 430). On the other hand, if the payload 244 is correctly decoded (the “Yes” branch of step 428), the TRP 102 adds the UE's preamble to the targeted FB section 364 (step 434) to form the targeted FB section 364 of the feedback message 304. The processing of this UE is then ended (step 446) and the TRP 102 starts to process another UE (from step 430).

Thus, the targeted FB section 364 of the feedback message 304 generated using the process 400D does not comprise any UE preambles marked as negative feedback.

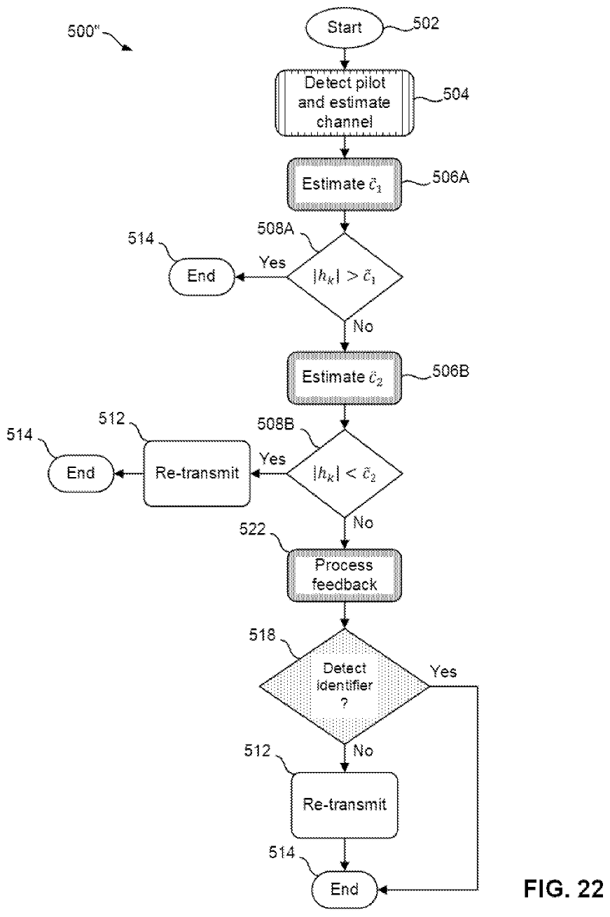

FIG. 22 is a flowchart showing a feedback-detection process 500D performed by a UE 114 for processing the feedback message generated by the TRP 102 using the process 400D shown in FIG. 21, according to some embodiments of this disclosure. The process 500D is similar to the process 500C shown in FIG. 19 except that at step 518, if the UE's preamble is detected in the targeted FB section 364 (the “Yes” branch of step 518), no retransmission is required and the process 500D ends (step 514); if the UE's preamble is not detected in the targeted FB section 364 (the “No” branch of step 518), the UE 114 then retransmits the data packet (step 512) and the process 500C ends (step 514).

Similar to the embodiments shown in FIGS. 11 to 14, in some embodiments, the thresholds \tilde{c}₁ and \tilde{c}₂ may be selected based on channel estimation conducted at an initialization stage of the system 100, historical channel estimation performed by the UEs 114 using the process 500C or 500D, and/or the like.

By using multiple thresholds (such as by using two channel amplitude thresholds \tilde{c}₁ and \tilde{c}₂), extra complexity reduction may be achieved at the UEs 114 compared to the prior-art methods and the embodiments using a single threshold since most of the UEs 114 do not need to process the second threshold-weighted pilot signal \tilde{c}₂p of the pilot section 362 and the targeted FB section 364 of the feedback message 304 (which is because most UEs 114 may successfully transmit data packets through channels above the first threshold \tilde{c}₁ and thus may stop further processing after the first threshold-weighted pilot signal \tilde{c}₁p of the pilot section 362 is processed). For example, test results have shown that the number of UEs 114 needing to process the targeted FB section 364 is reduced to only 5% to 20% of the total active UEs.

In above embodiments, one or more thresholds are used in constructing broadcast feedback messages 304 for URA communications. The use of the one or more thresholds classifies the UEs 114 into a plurality of categories and reduces the amount of specific or targeted or “personalized” feedback information, thereby significantly simplifying the processing of the feedback messages at the UEs 114. In the embodiments where multiple thresholds are used, the UE processing complexity is further reduced with most of the UEs not needing to process the targeted FB section 364 of the feedback messages at all.

The feedback message 304 is broadcasted to all users thereby avoiding the need of user-dedicated channels that may otherwise have to be introduced in URA. The feedback message 304 comprises the channel-estimating pilot, one or more thresholds, and the targeted FB section 364 which comprises a superposition of the preambles of a portion of the UEs 114 used in the feedforward link as the specific or targeted or “personalized” feedback information. The pilot, thresholds, its duration and waveform numerology can be communicated more generally through various NR resources.

In some embodiments where the UEs 114 may have previously obtained the channel estimation and the one or more thresholds (for example, in scenarios where the channels between the UEs 114 and the TRP 102 are relatively stable), the feedback messages 304 generated by the TRP 102 may not comprise the pilot signal p and the threshold-weighted pilot signal \tilde{c}p of pilot section 362.

With the use of the above-described broadcast feedback messages 304, various processes for constructing the broadcast feedback messages 304 at the TRP 102 and various processes for determining the need of retransmission at the UEs 114 are also described. More specifically, the TRP 102 may or may not include a (positive or negative) feedback in the targeted FB section 364 of the broadcast feedback messages 304 for a UE 114 depending on the UE's channel, the one or more thresholds, and the detection and decoding status of the UE's data packet.

On the UE side, each UE 114 may use the pilot section 362 of the feedback message 304 to estimate the channel and obtain the one or more thresholds. The UE then determines if retransmission of the data packet is needed based on the estimated channel, the one or more thresholds, and (if needed) the positive or negative feedback in the targeted FB section 364 of the feedback message 304.

The methods disclosed herein may be applicable to other multiple access applications where broadcast feedback is utilized (rather than feedback on dedicated UE resources/channels)

In some embodiments, the system 100 may use a simple, “positive-only” feedback method wherein the TRP 102 may form a feedback message comprising a superposition of preambles of the correctly detected/decoded UEs 114A. The TRP 102 broadcasts the feedback message to all UEs 114 to avoid the need of dedicated FB channels (which may be unavailable in URA). Each UE 114 detects and decodes the broadcast feedback message. The UEs identifying their preambles in the feedback message (that is, the UEs 114A) do not need to retransmit their data packets. Other UEs that do not identify their preambles in the feedback message retransmit their data packets.

The main drawback of the “positive-only” feedback method in these embodiments may be the high complexity of processing the feedback message by all UEs 114 as the number of the preambles in the feedback message (including those of UEs 114A1 and 114A2) is usually very high (for example, it is common that only 5% to 10% of FF-link messages are undecodable and thus usually the preambles of 90% to 95% UEs 114 would be included in the feedback message) and the UEs effectively may have to use the same AD algorithm as the one used by the TRP 102 (which has a high complexity).

Similarly, in some other embodiments, the system 100 may use a simple, “negative-only” feedback method wherein the TRP 102 may form a feedback message comprising a superposition of preambles of the undecoded UEs 114B. The TRP 102 broadcasts the feedback message to all UEs 114 to avoid the need of dedicated FB channels (which may be unavailable in URA). Each UE 114 detects and decodes the broadcast feedback message. The UEs 114 identifying their preambles in the feedback message (that is, the UEs 114A) retransmit their data packets. The UEs 114 that do not identify their preambles in the feedback message do not retransmit their data packets.

Compared to the “positive-only” feedback method, the “negative-only” feedback method doesn't incur such a high complexity because of the much lower number of the preambles in the feedback message (including those of UEs 114B1 and 114B2). However, one drawback of the “negative-only” feedback method in these embodiments is that the missed UE 114C would infer wrong positive feedback and would not retransmit their data packets. In addition, the UE feedback processing complexity may still be high since it is common that 5% to 10% of FF-link messages are undecodable.

While in above embodiments, the feedback message and the corresponding construction and processing processes are described for URA communications, in some other embodiments, the above-described feedback message and the corresponding construction and processing processes may be used in other multiple-access systems and applications where broadcast feedback is utilized. For example, in some embodiments, the above-described feedback message and the corresponding construction and processing processes may be used in sidelink data transmissions of a wireless communication system.

Herein, various embodiments have been described. With the above description, those skilled in the art will appreciate that the embodiments disclosed herein are for illustrative purpose only and alternatives are readily available. For example, in above-described processes, the steps thereof may be modified, reordered, combined, separated, added, and/or deleted in any suitable manner to achieve the same or similar functionalities.

In various embodiments, some of the above-described methods or some steps thereof may be combined with other suitable methods or steps thereof. For example, in the process 400A shown in FIG. 12, steps 440 and 444 may be substituted with a step of adding UE's preamble to the targeted FB section with a negative indicator (that is, no comparison of the channel and the threshold \tilde{c} if the data packet is undecodable). Similarly, steps 430 and 434 may be substituted with a step of adding UE's preamble to the targeted FB section with a positive indicator (that is, no comparison of the channel and the threshold \tilde{c} if the data packet is decoded).

Those skilled in the art will appreciate that some or all methods described above may experience nonzero feedback errors due to various causes. However, at least in some practical applications (such as URA) and in some practical situations, the probability of experience such nonzero feedback errors is small and acceptable.

In some embodiments, a UE 114 retransmits the data packets if it detects its preamble associated with a negative indicator (or marked as negative feedback) in the targeted FB section 364 of the feedback message 304, regardless the comparison between its channel amplitude and the one or more thresholds.

In above embodiments, two feedback types are used in forming the feedback message 304. In some embodiments, the feedback message 304 may only comprise one feedback type (denoted the first feedback type) such as the negative feedback associated with the respective UE preambles (that is, the respective UE IDs). While the other feedback type (denoted the second feedback type) is not explicitly associated with any UE preambles in the targeted FB section 364 of the feedback message 304, the second feedback type may be considered a “default” feedback type and may be derived from the determination that the UE preambles in the targeted FB section 364 of the feedback message 304 are not associated with the first feedback type.

### C. Acronym Key

URA: Unsourced Random Access
TRP: Transmit/Receive Point
UE: User Equipment
FF: Feed-Forward
FB: Feedback
PUPE: Per User Probability of Error
AD: Activity Detection
MUD: Multi-user Detection

### D. References

[R1] Y. Polyanskiy, “A perspective on massive random-access,” in IEEE Int. Symp. On Inform. Theory, Aachen, Germany, June 2017, pp. 2523-2527.
[R2] O. Ordentlich and Y. Polyanskiy, “Low complexity schemes for the random access Gaussian channel,” in IEEE Int. Symposium on Information Theory, June 2017, pp. 2528-2532.
[R3] V. K. Amalladinne, J.-F. Chamberland, and K. R. Narayanan, “A coded compressed sensing scheme for uncoordinated multiple access,” IEEE Transactions on Information Theory 66.10 (2020): 6509-6533.
[R4] A. Vem, K. Narayanan, J.-F. Chamberland, and J. Cheng, “A user independent successive interference cancellation based coding scheme for the unsourced random access Gaussian channel,” IEEE Trans. Commun., vol. 67, no. 12, pp. 8258-8272 December 2019.
[R5] A. Fengler, P. Jung, and G. Caire, “SPARCs and AMP for unsourced random access,” in IEEE Int. Symp. on Information Theory, Paris, France, July 2019, pp. 2843-2847.
[R6] K. Amalladinne, A. K. Pradhan, C. Rush, J.-F. Chamberland, and K. R. Narayanan, “On approximate message passing for unsourced access with coded compressed sensing,” in Proc. IEEE Int. Symp. Inf. Theory (ISIT), June 2020, pp. 2995-3000.
[R7] E. Marshakov, G. Balitskiy, K. Andreev, and A. Frolov, “A polar code based unsourced random access for the Gaussian MAC,” in 2019 IEEE90th Vehicular Technology Conference (VTC2019-Fall), September 2019, pp. 1-5.
[R8] G. K. Facenda and D. Silva, “Efficient scheduling for the massive random access Gaussian channel,” IEEE Transactions on Wireless Communications, vol. 19, no. 11, pp. 7598-7609, 2020.
[R9] J. Kang and W. Yu, “Minimum feedback for collision-free scheduling in massive random access,” in 2020 IEEE International Symposium on Information Theory (ISIT). IEEE, 2020, pp. 2989-2994.
[R10] U.S. Pat. No. 10,986,670, entitled “Random access feedback method, random access processing method, base station and terminal,” to Ren, et al.
[R11] S.-H. Lee, B. C. Jung, and S.-W. Jeon, “Successive interference cancellation with feedback for random access networks,” IEEE Communications Letters, vol. 21, no. 4, pp. 825-828, 2016.
[R12] J. Choi, “On throughput of compressive random access for one short message delivery in IoT,” IEEE Internet of Things Journal, vol. 7, no. 4, pp. 3499-3508, 2020.
[R13] R. Kotaba, A. E. Kalor, P. Popovski, I. Leyva-Mayorga, B. Soret, M. Guillaud, and L. G. Ordonez, “How to identify and authenticate users in massive unsourced random access,” IEEE Communications Letters 25.12 (2021): 3795-3799.
[R14] D. Truhachev, M. Bashir, A. Karami, and E. Nassaji, “Low-complexity coding and spreading for unsourced random access,” IEEE Commun. Lett., vol. 25, no. 3, pp. 774-778, March 2021.
[R15] Kotaba, R., Kalor, A. E., Popovski, P., Leyva-Mayorga, I., Soret, B., Guillaud, M. and Ordóñez, L. G., Unsourced Random Access With Authentication and Joint Downlink Acknowledgements. In 2021 55th Asilomar Conference on Signals, Systems, and Computers (pp. 1496-1501). IEEE.
[R16] Alexander Fengler, Peter Jung, and Giuseppe Caire, “SPARCs for Unsourced Random Access,” IEEE Transactions on Information Theory, vol. 67, no. 10, October 2021.

Although embodiments have been described above with reference to the accompanying drawings, those of skill in the art will appreciate that variations and modifications may be made without departing from the scope thereof as defined by the appended claims.

1. A method comprising:
broadcasting a message to a plurality of communication devices;
wherein the message comprises one or more first identifiers representing one or more first communication devices of the plurality of communication devices; and
wherein one or more first packets transmitted from the one or more first communication devices via one or more first channels have been successfully received and decoded, and amplitudes of the one or more first channels are smaller than a first threshold.

2. The method of claim 1, wherein the one or more first identifiers comprise one or more first preambles of the one or more first communication devices, and/or are associated with a first feedback type.

3. The method of claim 1, wherein the message further comprises one or more second identifiers representing one or more second communication devices of the plurality of communication devices; and
wherein one or more second packets transmitted from the one or more second communication devices via one or more second channels have been received but failed to decode, and amplitudes of the one or more second channels are greater than the first threshold.

4. The method of claim 3, wherein the one or more second identifiers are associated with a second feedback type, and/or comprise one or more second preambles of the one or more second communication devices.

5. The method of claim 1, wherein the message further comprises one or more second identifiers associated with a second feedback type, the one or more second identifiers representing one or more second communication devices of the plurality of communication devices; and
wherein one or more second packets transmitted from the one or more second communication devices via one or more second channels have been received but failed to decode, and amplitudes of the one or more second channels are smaller than the first threshold and greater than a second threshold.

6. The method of claim 1, wherein the message further comprises a first pilot signal; or
wherein the message further comprises a first pilot signal and a second pilot signal, the second pilot signal being the first pilot signal multiplied by the first threshold.

7. The method of claim 6, wherein the message further comprises one or more second identifiers associated with a second feedback type, the one or more second identifiers representing one or more second communication devices of the plurality of communication devices;
wherein one or more second packets transmitted from the one or more second communication devices via one or more second channels have been received but failed to decode, and amplitudes of the one or more second channels are smaller than the first threshold and greater than a second threshold; and
wherein the message further comprises a third pilot signal, the third pilot signal being the first pilot signal multiplied by the second threshold.

8. An apparatus comprising:
a processor for:
broadcasting a message to a plurality of communication devices;
wherein the message comprises one or more first identifiers representing one or more first communication devices of the plurality of communication devices; and
wherein one or more first packets transmitted from the one or more first communication devices via one or more first channels have been successfully received and decoded, and amplitudes of the one or more first channels are smaller than a first threshold.

9. The apparatus of claim 8, wherein the one or more first identifiers comprise one or more first preambles of the one or more first communication devices, and/or are associated with a first feedback type.

10. The apparatus of claim 8, wherein the message further comprises one or more second identifiers representing one or more second communication devices of the plurality of communication devices; and
wherein one or more second packets transmitted from the one or more second communication devices via one or more second channels have been received but failed to decode, and amplitudes of the one or more second channels are greater than the first threshold.

11. The apparatus of claim 10, wherein the one or more second identifiers are associated with a second feedback type, and/or comprise one or more second preambles of the one or more second communication devices.

12. The apparatus of claim 8, wherein the message further comprises one or more second identifiers associated with a second feedback type, the one or more second identifiers representing one or more second communication devices of the plurality of communication devices; and
wherein one or more second packets transmitted from the one or more second communication devices via one or more second channels have been received but failed to decode, and amplitudes of the one or more second channels are smaller than the first threshold and greater than a second threshold.

13. The apparatus of claim 8, wherein the message further comprises a first pilot signal; or
wherein the message further comprises a first pilot signal and a second pilot signal, the second pilot signal being the first pilot signal multiplied by the first threshold.

14. One or more non-transitory computer-readable storage devices comprising computer-executable instructions, wherein the instructions, when executed, cause a processor to perform actions comprising:
broadcasting a message to a plurality of communication devices;
wherein the message comprises one or more first identifiers representing one or more first communication devices of the plurality of communication devices; and
wherein one or more first packets transmitted from the one or more first communication devices via one or more first channels have been successfully received and decoded, and amplitudes of the one or more first channels are smaller than a first threshold.

15. The one or more non-transitory computer-readable storage devices of claim 14, wherein the one or more first identifiers comprise one or more first preambles of the one or more first communication devices, and/or are associated with a first feedback type.

16. The one or more non-transitory computer-readable storage devices of claim 14, wherein the message further comprises one or more second identifiers representing one or more second communication devices of the plurality of communication devices; and
wherein one or more second packets transmitted from the one or more second communication devices via one or more second channels have been received but failed to decode, and amplitudes of the one or more second channels are greater than the first threshold.

17. The one or more non-transitory computer-readable storage devices of claim 16, wherein the one or more second identifiers are associated with a second feedback type, and/or comprise one or more second preambles of the one or more second communication devices.

18. The one or more non-transitory computer-readable storage devices of claim 14, wherein the message further comprises one or more second identifiers associated with a second feedback type, the one or more second identifiers representing one or more second communication devices of the plurality of communication devices; and
wherein one or more second packets transmitted from the one or more second communication devices via one or more second channels have been received but failed to decode, and amplitudes of the one or more second channels are smaller than the first threshold and greater than a second threshold.

19. The one or more non-transitory computer-readable storage devices of claim 14, wherein the message further comprises a first pilot signal; or
wherein the message further comprises a first pilot signal and a second pilot signal, the second pilot signal being the first pilot signal multiplied by the first threshold.

20. The one or more non-transitory computer-readable storage devices of claim 19, wherein the message further comprises one or more second identifiers associated with a second feedback type, the one or more second identifiers representing one or more second communication devices of the plurality of communication devices;
wherein one or more second packets transmitted from the one or more second communication devices via one or more second channels have been received but failed to decode, and amplitudes of the one or more second channels are smaller than the first threshold and greater than a second threshold; and
wherein the message further comprises a third pilot signal, the third pilot signal being the first pilot signal multiplied by the second threshold.
